(19) United States
(12) Patent Application Publication
(10) Pub. No.: US 2003/0140551 A1
(43) Pub. Date: Jul. 31, 2003

(54) Transparent candle

(76) Inventors: Taizo Noda, Kanagawa (JP); Yasushi Kaga, Kanagawa (JP); Daijiro Ohtani, Kanagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/352,161

(22) Filed: Jan. 28, 2003

(30) Foreign Application Priority Data
Jan. 29, 2002 (JP) 2002-19834

(51) Int. Cl. C10L 5/00; C10L 7/00; C11C 5/00

(52) U.S. Cl. 44/275

(57) ABSTRACT

To improve production efficiency and continue good burning, and to avoid to carry out troublesome separation and discarding with use of container made of glass or metals, it is provided a transparent candle having a container filled with a candle composition, the candle composition having a wick embedded therein, wherein the candle composition has a melting point of 50° C. to 70° C. while the container is formed mainly of natural wax having a melting point higher than the melting point of the candle composition. All of these materials can utilize natural materials to decrease the melting point of the candle composition, thereby resulting in not only a reduced consumption of energy required for melting the materials during manufacturing and an improved production efficiency, but also better soaking up by the wick due to its melting at low temperatures, no accumulation of soot in the wick, and allowing flames not to go out even when burning is continued.

### BACKGROUND OF THE INVENTION

1. Field of the Invention

The present invention relates to a transparent candle formed by filling a candle composition into a given container.

2. Related Arts

As conventional techniques of this kind, it is known such structures as disclosed, for example, in Japanese Patents 58-201900(A) and 58-217597(A), either of which discloses inventions directed to candle compositions.

The prior art described in the above-mentioned Japanese Patent 58-201900(A) is directed to a candle composition having flammable organic solvents solidified with a gelling agent of an organic compound, and describes the use of “Gel All D” (a trademark for a product of New Japan Chemical Co., Ltd.) as the gelling agent, which is derived from the condensation reaction of sorbitol and benzaldehyde and is a chemically neutral, hydrophobic, heat-resistant, powdery gelling agent.

In the prior art described in the above-mentioned Japanese Patent 58-217597(A), the candle composition comprises benzylidene sorbitol and plant oil, wherein the benzylidene sorbitol is in the range of 0.5 to 5 parts by weight relative to 100 parts by weight of the plant oils, and are formed by mixing these materials and putting the mixture in a container made of materials such as glass. As benzylidene sorbitol, mono-, di-, and tri-benzylidene sorbitols, and derivatives thereof are mentioned therein.

Gelling agents used in these known techniques, however, have melting points of 100° C. or higher, giving rise to disadvantages of not only poor efficiency in manufacturing due to requiring an extended time for complete melting of a candle composition and causing energy loss upon production, but also making it worse to soak up a melted composition into the wick because of their high melting points, and causing relatively small flames and moreover soot accumulation in the wick, with the result that flames may go out when burning is continued.

In addition, these candle compositions are in a state of gel, and the compositions are held in containers made of glass or metal for retaining their shapes. For this reason, it is necessary after burning to separate and discard disposable containers as incombustibles, even if troublesome.

For conventional transparent candles, therefore, there are problems to be solved in that the melting point of candle compositions is reduced so that an improved production efficiency and good burning can be achieved and in that they are designed so as not to use containers made of glass or metals which are to carry out troublesome separation and discarding.

### SUMMARY OF THE INVENTION

According to the present invention, there is provided, as specific means to solve above-described problems of conventional candles, a transparent candle having a container filled with a candle composition, the candle composition having a wick embedded therein, wherein the candle composition has a melting point of 50° C. to 70° C. while the container is formed mainly of natural wax having a melting point higher than the melting point of the candle composition.

Since the candle composition has a low melting point as stated above, there are provided good soaking up by the wick, its burning with large and soft-feeling flames, and no accumulation of soot in the wick, so that flames do not go out even and burning is continued to the end. In addition, there are also provided effects capable of not only resolving energy loss during manufacturing, but also improving the production efficiency. Furthermore, since the container of the transparent candle is mainly formed of natural wax as stated above, the transparent candle of the present invention can be discarded as an ordinary flammable waste, after use.

If the candle composition has a melting point lower than the lower limit of 50° C., the candle composition would undesirably melt and spill out of the container during transport under some circumstances, even at normal temperature. Therefore, the lower limit of the melting point of the candle composition is 50° C. in order to avoid the possible deficiencies. The transparency of the candle composition becomes lower as the melting point of the candle composition is higher, while a melting point of the candle composition for keeping a desirable transparency of the composition is 70° C. or lower. Therefore, the upper limit of the melting point of the candle composition is 70° C.

Allowing a distance between a side wall of the container and the wick to be at least 15 mm, the container is not melted with the burning at the wick, which allows only the candle composition to be melted to burn to the end. As natural waxes to be used for the container, natural waxes having relatively high melting points of 70° C. or higher, for example, Chinese wax, carnauba wax, rice wax, candelilla wax, and others, are used.

Forming the container so as to have an outer diameter of 40 to 50 mm and a thickness of the side wall of 3 to 4 mm, the container can be kept to have the desirable and excellent transparency, while the candle composition can be efficiently burned.

Forming the candle composition of 50 to 90% by weight of plant fat and oil, 5 to 40% by weight of natural wax, and 1 to 10% by weight of hydrogenated castor oil or a fat and oil gelling agent, the candle composition can have a melting point in the range of 50° C. to 70° C., and can be made into safe candles having an excellent transparency.

The container may be formed of 100% by weight of the natural wax mentioned above, while the natural wax may be mixed with plant fat and oil for forming the container. In case of mixing the natural wax with the plant fat and oil, 50 to 99% by weight of natural wax and 1 to 50% by weight of plant fat and oil are mixed with each other at amounts selected as appropriate. Namely, by forming the container of 50 to 100% by weight of natural wax and 0 to 50% by weight of plant fat and oil, the container can have a melting point of higher than 70° C. and can be translucent. The melting point of the container is preferably 90° C. or lower from the viewpoint of translucency and production efficiency.

Furthermore, by allowing the candle composition to contain any one or more of aromatics, dyes, and pigments, the candle can have varieties of fragrance or aroma and appearance.

### BRIEF DESCRIPTION OF THE DRAWING

FIGURE 1 is a perspective view showing a transparent candle according to an embodiment of the present invention.

### DETAILED DESCRIPTION OF PREFERRED EMBODIMENT

The following describes the present invention in detail with reference to specific embodiments thereof.

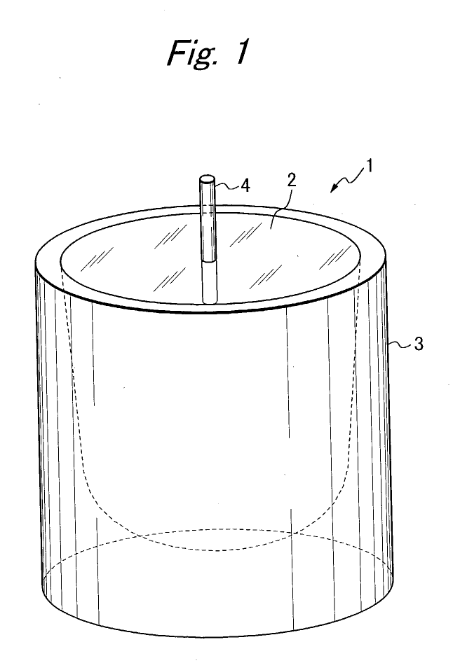

FIGURE 1 is a perspective view showing a transparent candle 1 according to the present invention. The transparent candle 1 is composed of a candle composition 2 and a container 3 into which the candle composition is filled for retaining its shape, the candle composition 2 having a wick 4 embedded therein with its upper end exposed for lighting the candle.

### EXAMPLE

50 to 90% by weight of plant fat and oil, 5 to 40% by weight of natural wax, and 1 to 10% by weight of hydrogenated castor oil or a fat and oil gelling agent, are mixed at amounts selected as appropriate in order to prepare a candle composition 2.

As plant fats and oils, fats and oils having relatively low melting points of 70° C. or less, such as linseed oil, cotton seed oil, rapeseed oil, castor oil, sunflower oil, or camellia oil were used. As natural waxes to be used for the candle composition, beeswax, carnauba wax, candelilla wax, Japan wax (or sumac wax), Chinese wax (or insect wax), or others were used. As a fat and oil gelling agent, 12-hydroxystrearic acid was utilized.

The candle composition 2 thus prepared can be visually recognized to be in a transparent state as a whole.

On the other hand, a container 3 was formed of 100% by weight of natural wax, while another containers 3 were formed by mixing 50 to 99% by weight of natural wax with 1 to 50% by weight of castor oil at amounts selected as appropriate. As the natural wax, “Yuki-Rou” (a trademark for a product of Cera Rica NODA Co., Ltd.), which is produced by refining Chinese wax, was used. Surfaces of the containers thus formed can be visually recognized to be in a translucent state.

By utilizing natural materials as main components as described above, there were provided transparent candles 1 each of which comprises a candle composition 2 having a melting point in the range of 50° C. to 70° C. and a container 3 having a melting point in the range of 70° C. to 90° C.

Forming of the container 3 in this way, the candle composition 2 does not need any glass or metallic containers, and can hold properties of retaining shapes as a transparent candle, even if the candle composition 2 is in a state of gel. Further, since the transparent candle 1 is formed of natural materials as stated above, the candle after use can be reused as raw materials for new candles, and can be discarded as flammable waste in the case of discarding it, because it is flammable. Moreover, the container 3 gives little influence on the natural environment, when the container is buried in the ground.

In manufacturing a transparent candle 1, a container 3 having a relatively high melting point is formed in advance, followed by filling the container with a melted candle composition 2 having a relatively low melting point, during which the container 3 seems to be in a state to be broken with ease due to difference in temperature raised between the container 3 and the melted candle composition 2. However, since the temperature of the melted candle composition is not so high due to the relatively low melting point, the difference in temperature is not so great as to cause breaking of the container 3. In addition, if plant fats and oils are contained in the container 3, flexibility of the container 3 is increased, whereby breaking due to the difference in temperature does not take place at all, and it facilitates molding step for forming the container 3.

In general, the flame temperature of a candle is about 600 to 1400° C. By setting the radius of the internal diameter of a container 3 being 1.5 cm or more, some distance between the wick 4, the origin of the flame, and the container 3 can be provided, and thus only the candle composition 2 can be burned through the wick 4 while retaining the shape of the container 3. In addition, the use of Yuki-Rou (a trademark for a product of Cera Rica NODA Co., Ltd.) or the like for the container 3 displays its characteristically translucent white color, and since it has large crystals, portion of the candle composition 2 having a low melting point goes into between crystals of the shell 3, resulting in irregular reflection of the light from the flame, thereby increasing the transparency and at the same time, allowing visual recognition of the container 3 with a faint light, giving a soft feeling.

In the transparent candle 1 as described above, a candle composition 2 to be burned is formed by holding the composition in a container 3 or filling the composition into a container 3, whereby the candle composition 2 does not overflow outside and dripping of melted wax or the like does not take place. Therefore, the transparent candle 1 according to the present invention has increased safety.

Additionally, the melting point of a candle composition 2 to be burned can be decreased below 70° C. by using natural materials for the whole of a transparent candle 1, which provides a decreased period of time required for melting the materials during manufacturing, reduces the consumption of energy for melting, and improves the production efficiency. Besides them, when the candle is used, the candle composition 2 melts at low temperatures, thereby resulting in good soaking up by the wick and no accumulation of soot in the wick, and allowing flames not to go out even when burning is continued.

Furthermore, since natural materials are employed as the main component, there are not generated any odor characteristic of oil as in synthetic products in which oil and others are contained and any irritating smell even after burning.

What is claimed is:

1. A transparent candle having a container filled with a candle composition, the candle composition having a wick embedded therein, wherein the candle composition has a melting point of 50° C. to 70° C. while the container is formed mainly of natural wax having a melting point higher than the melting point of the candle composition.

2. A transparent candle according to claim 1, wherein a distance between a side wall of the container and the wick is at least 15 mm.

3. A transparent candle according to claim 2, wherein the container has an outer diameter of 40 to 50 mm and the side wall has a thickness of 3 to 4 mm.

4. A transparent candle according to claim 1, wherein the candle composition is formed of 50 to 90% by weight of plant fat and oil, 5 to 40% by weight of natural wax, and 1 to 10% by weight of hydrogenated castor oil or a fat and oil gelling agent.

5. A transparent candle according to claim 1, wherein the container is formed of 50 to 100% by weight of natural wax and 0 to 50% by weight of plant fat and oil.

6. A transparent candle according to any one of claims 1 to 5, the candle composition contains any one or more of aromatics, dyes, and pigments.
